(19) United States
(12) Patent Application Publication
(10) Pub. No.: US 2022/0147939 A1
(43) Pub. Date: May 12, 2022

(54) INFORMATION PROCESSING DEVICE

(71) Applicant: HIROTSU BIO SCIENCE INC., Tokyo (JP)

(72) Inventors: Takaaki HIROTSU, Tokyo (JP); Naoki SAKAKIBARA, Tokyo (JP)

(21) Appl. No.: 17/614,984

(22) PCT Filed: May 28, 2020
(86) PCT No.: PCT/JP2020/021123

§ 371 Date: Nov. 29, 2021

(30) Foreign Application Priority Data
May 30, 2019 (JP) 2019-101645

(51) Int. Cl. G06Q 10/10

(52) U.S. Cl. CPC G06Q 10/101; G06Q 10/103

(57) ABSTRACT

To provide a research result distribution platform that is highly convenient for researchers and people trying to use research results. A research result acquisition unit 111 acquires research result information indicating results of research of researchers R. A management unit 102 manages one or more pieces of research result information acquired by the research result acquisition unit 111, for each researcher R. An extraction unit 103 extracts the research result information desired by a user U from the one or more pieces of research result information managed by the management unit 102. A research result presentation unit 141 presents the research result information extracted by the extraction unit 103 to the user U. The problem is solved thereby.

### RELATED APPLICATION INFORMATION

This patent claims priority from International PCT Patent Application No. PCT/JP2020/021123, filed May 28, 2020, entitled, “INFORMATION PROCESSING DEVICE”, which claims priority to Japanese Patent Application No. 2019-101645, filed May 30, 2019 all of which are incorporated herein by reference in their entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Technical Field

The present invention relates to an information processing device.

### Background Art

In some conventional techniques, the contents of research by researchers can be searched for and browsed. For example, Patent Document 1 describes a technique regarding a joint research/joint venture matching system for performing matching between companies and researchers outside the companies.

Patent Document 1: Re-publication of PCT International Publication No. 2008-004563.

### SUMMARY OF THE INVENTION

### Problems to be Solved by the Invention

However, it has been desired to develop a research result distribution platform that is more convenient for researchers and those who want to use research results than the conventional techniques including the Patent Document 1 described above.

The present invention has been made in view of such circumstances, and it is an object of the present invention to provide a research result distribution platform that is highly convenient for researchers and those who want to use research results.

### Means for Solving the Problems

In order to achieve the above object, an information processing device in one aspect of the present invention includes: a first acquisition unit that acquires first information indicating a result of research by a researcher; a management unit that manages, for each researcher, at least one piece of the first information acquired by the first acquisition unit; and an extraction unit that extracts first information desired by a user, the first information being among the at least one piece of the first information managed by the management unit; and a first presentation unit that presents the first information extracted by the extraction unit, to the user.

### Effects of the Invention

According to the present invention, a research result distribution platform that is highly convenient for researchers and those who want to use research results can be provided.

### BRIEF DESCRIPTION OF THE DRAWINGS

FIG. 1 is a diagram illustrating an overview of a service that can be provided by an information processing system including a server according to one embodiment of an information processing device of the present invention;

FIG. 2A is a diagram illustrating a relationship between an action and a service point;

FIG. 2B is a diagram illustrating a relationship between an action and the service point;

FIG. 3 is a diagram illustrating a specific example of a proprietary format provided by a research posting service included in the service;

FIG. 4 is a diagram illustrating an overview of a recruit automatic scouting service included in the service;

FIG. 5 is a diagram illustrating a configuration of the information processing system including the server according to one embodiment of the information processing device of the present invention;

FIG. 6 is a block diagram illustrating one example of a hardware configuration of the server included in the information processing system illustrated in FIG. 5; and

FIG. 7 is a functional block diagram illustrating functional components for executing research result utilization support processing, out of functional components of the server in FIG. 6.

### DETAILED DESCRIPTION OF THE PREFERRED MODE FOR CARRYING OUT THE INVENTION

Hereinafter, an embodiment of the present invention will be described with reference to drawings.

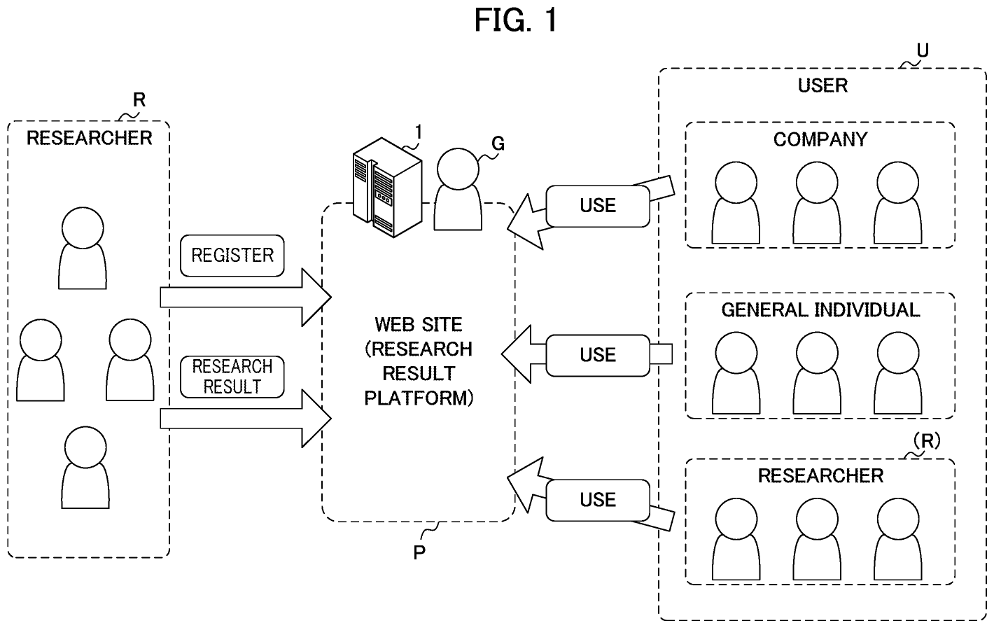

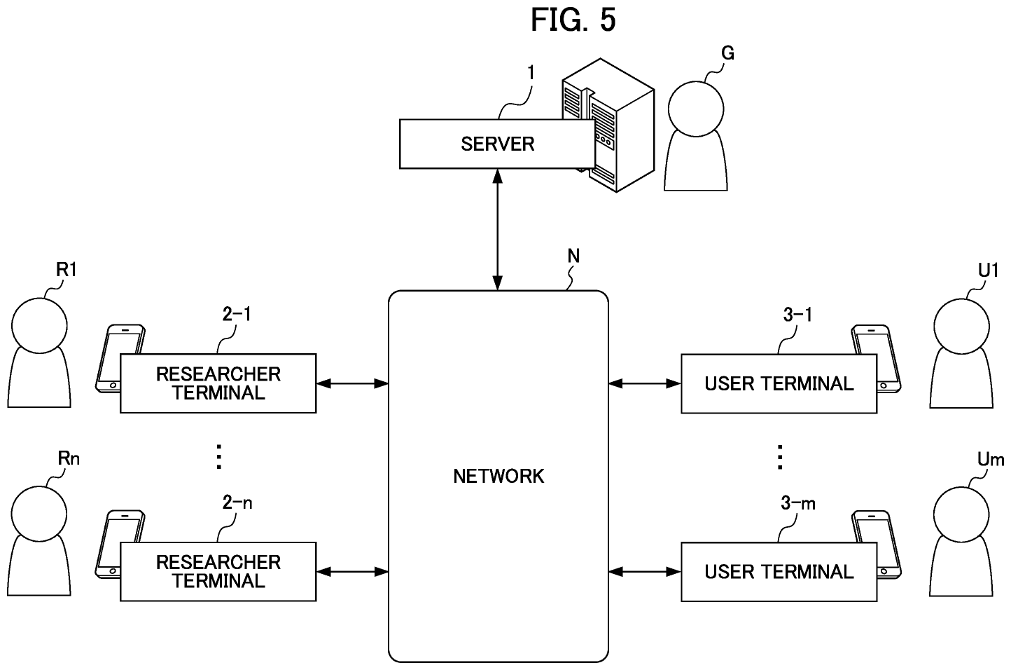

First, an overview of a service (hereinafter, referred to as “the service”) that is applied in an information processing system to which an information processing device of the present invention is applied (refer to FIG. 5 described later) will be described with reference to FIG. 1 to FIG. 4.

FIG. 1 is a diagram illustrating an overview of the service that can be provided by an information processing system including a server according to one embodiment of the information processing device of the present invention.

The service is one example of a service provided by a service provider G. In the service, support for matching is performed between a result of research (hereinafter, referred to as “research result”) by a person R who conducts various kinds of research (hereinafter, referred to as “researcher R”) and a person U who wants to use the research result (hereinafter, referred to as “user U”). There are said to be more than a million researchers in Japan. However, there has not been a technique for achieving complete and effective utilization of the research results of those many researchers R. Therefore, there are also said to be many research results that have the potential for creating social value but have not seen the light of day yet.

The service supports both researchers R and users U by providing a platform P that allows professional knowledge of many researchers R to be easily distributed on the web (hereinafter, referred to as “research result distribution platform P”). More specifically, according to the service, a researcher R can easily make a posted research result distributed only by registering own personal information (hereinafter, referred to as “researcher information”) and posting a research result on the research result distribution platform P. In addition, a user U of the service can easily browse and view a desired research result only by accessing the research result distribution platform P and performing a predetermined search operation. As for a user U of the service, as illustrated in FIG. 1, for example, not only a company and a general individual, but also a researcher R who can post a research result can use the research result distribution platform P as the user U. This allows the researcher R to do browsing and the like of research results of other researchers R, thereby being able to make use of them for its own research.

In addition, each of the researcher R and the company as a user U who are supported by the service can gain the following benefits, for example. That is, the researcher R can gain the benefits of: (1) being able to easily obtain a place for presentation of its own research result; (2) being able to get in contact with a company as a user U; (3) allowing an active activity (action) on the research result distribution platform P to lead to acquisition of a predetermined incentive that can be converted into a research fund (e.g., a service point described later); (4) capturing more attention by appearing in a feature article or the like on the research result distribution platform P; (5) being able to easily cope with a different format for each application form in various grant applications and the like; and the like. In addition, the company as a user U can gain the benefits of: (1) being able to easily recruit a researcher R; (2) being able to easily provide an offer of a joint research to a researcher R; (3) being able to get a clue in development in the company by browsing research results; (4) being able to ask a researcher R to offer a proposal of measures for solving a problem of the own company; (5) being able to expect an advertising effect by having a researcher R review a product of the company; and the like. Furthermore, the company as a user U is also (6) able to advertise its own product from a position as a researcher R by performing joint research with a researcher R, for example.

The following will specifically describe details of the service that is provided by the service provider G. Examples of specific services that utilize the research result distribution platform P which is used by researchers R and users U who receive provision of the service include a research posting service, a problem solving support service, a recruit automatic scouting service, a record creation service, and a lab sharing service.

Among the specific services that utilize the research result distribution platform P, the “research posting service” is a service provided for the purpose of letting people around the world know about research results by presenting the research results in and outside the country. In the research posting service, research results posted by researchers R can be presented in and outside the country using a proprietary format for the research result distribution platform P (hereinafter, referred to as “proprietary format”). That is, since research results posted by researchers R have been created in various formats, conversion into an easily manageable proprietary format is performed. Note that a specific method for the conversion is not particularly limited. For example, text data included in a research result that has been created using various kinds of word processor software, spreadsheet software, and the like may be automatically coded by being fed into a proprietary HTML for the research result distribution platform P. This makes it possible for researchers R to easily perform editing of research results posted on the research result distribution platform P, with text, still images, and moving images on the proprietary format. In addition, by tagging the proprietary format, it can be expected that people other than those who use the service will be interested in the service. As a result, it can be expected that the number of people who want to use the service as a researcher R or a user U among people who have not used the service yet will increase.

In the research posting service, posted research results are introduced in a ranking format. This can create topics on researchers R and users U. In addition, appealing effects through various media can also be expected. More specifically, a ranking with the title of, for example, “Ranking of researcher points”, “Ranking of research selected by prominent scholars”, “Ranking of research soon to be commercially available”, “Ranking of favorite research selected by elementary school students”, or “Definitive edition! National general election/top-ten annual research awards” can be assumed. The “Ranking of researcher points” among the above various rankings is a ranking based on the number of points that a researcher R can gain by actively using the service (hereinafter, referred to as “the service point”).

The service point here refers to a point as an incentive that is given for each researcher R. The researcher R can gain the service point when taking action actively in various situations and receiving some action from a user U in using the research result distribution platform P. More specifically, for example, the researcher R can gain the service point when (1) posting a research result, (2) obtaining an evaluation from a user U, (3) receiving an offer to exchange business cards from a company as a user U, (4) presenting a solution to a problem that has been presented from a company as a user U, (5) a presented solution is adopted, and (6) presenting a feedback or comment to a research result that has been posted by another researcher R. Here, the “evaluation from a user U” includes a review from a user U and the number of times of pressing a predetermined button that a user U presses in making a favorable evaluation (e.g., “LIKE IT” button, or “Like” button). The researcher R can gain and accumulate the service point. The accumulated service points can be converted into a predetermined currency such as Japanese yen or can be exchanged to predetermined points that are managed by another point service. This also allows the researcher R to convert the accumulated points into cash to add to their own research funds.

That is, the service point is not given when a researcher R or the like consumes cash in the service, but given when they take an active activity (action). In addition, the researcher R accumulates the service point and thereby, can exchange it for a research fund. The service point is given to individual researchers R; however, it can be combined among researchers R. In this case, in applying for exchange of the service point to a research fund, application is performed under the name of a representative. More specifically, for example, the service points of individuals in the same laboratory can be combined. Therefore, when purchasing expensive laboratory equipment in the laboratory, part of its price can be covered by using the combined service points. Note that the “research fund” mentioned here is not especially limited; for example, in a shopping site of a laboratory equipment trading company in partnership with the service (hereinafter, referred to as “partnership shopping site”), it can be the amount of cash to which the service point can be converted. In this case, the researcher R can freely purchase laboratory equipment and the like at the partnership shopping site within the range of an amount after conversion of the accumulated service points into a research fund. At the time of settlement, the service points and cash can be combined.

In addition, in addition to the aspect described above, there is also an aspect in which the service points that can be gained by a researcher R can be divided into two kinds. In the case of this aspect, a user U gains or loses only a first service point during use of the service. In addition, the researcher R gains or loses each of the first service point and a second service point during use of the service.

The first service point is a point that can be gained by each of the user U and the researcher R according to the number of actions. The second service point is a point that can be gained by the researcher R and has a function as electronic money. In order for the researcher R to gain the second service point, the first service point has to be gained as its precondition. That is, the first service point for the researcher R is positioned as a point for gaining the second service point.

The user U can use the problem solving support service described later and make an investment in the researcher R, by using the first service point. Therefore, the user U browses many research results so as to gain the first service point. This allows the researcher R to have more opportunities to let more users U know about their own inventive results. As a result, motivation for research of the researcher R can be enhanced. That is, the first service point functions as a point that allows both the user U and the researcher R to gain benefits. In addition, the second service point is expected to have an effect of allowing fund management on the research result distribution platform P to be simplified.

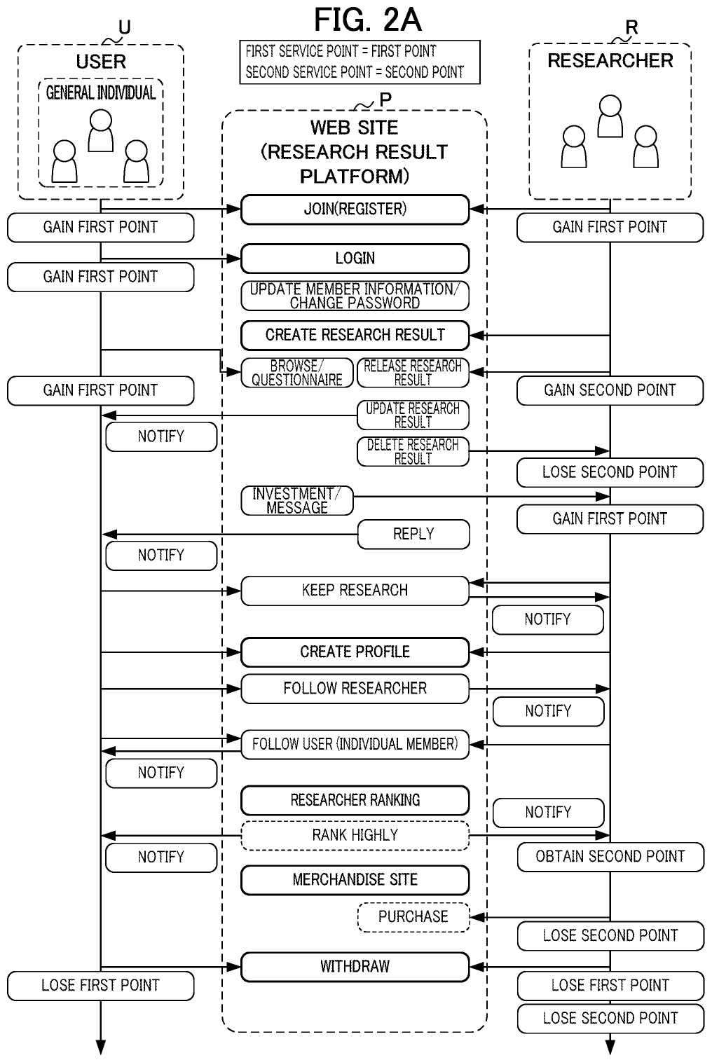

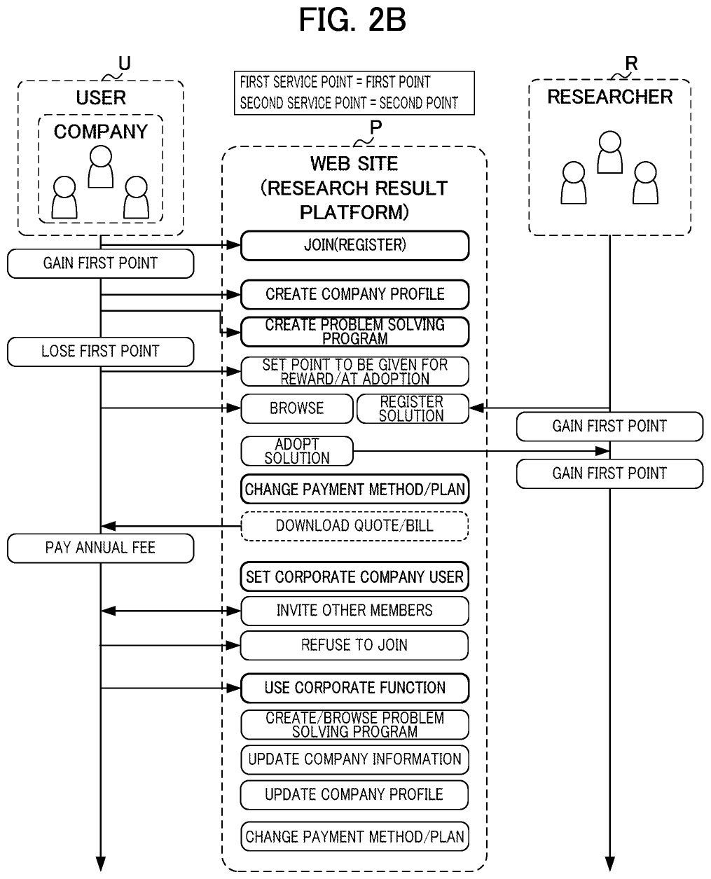

FIG. 2A and FIG. 2B are diagrams illustrating a relationship between an action and the service point.

FIG. 2A illustrates a specific example of the service point that, in the case where the user U is an individual, is gained or lost by the user U or researcher R for each action. FIG. 2B illustrates a specific example of the service point that, in the case where the user U is a corporation, is gained or lost by the user U or researcher R for each action.

As illustrated in FIG. 2A and FIG. 2B, each of the user U and researcher R gains the first service point, for example, at the following timings. That is, the user U gains the first service point at the timing of joining (registering) the service, the timing of logging in to the service, and the timing of browsing a research result. In addition, the user U gains the first service point at the timing of making the setting of the first service point that is to be given at the time of rewarding and adoption. The researcher R gains the first service point at the timing of joining (registering) the service, the timing of receiving an investment from the user U, and the timing of receiving a message from the user U. In addition, the researcher R gains the first service point at the timing of presenting (releasing) a solution (research result) to a problem that has been presented from the user U and the timing when the presented solution is adopted. Furthermore, although not illustrated, the researcher R gains the first service point also at the timing of being provided with the first service point from the user U.

Also, as illustrated in FIG .2A and FIG. 2B, each of the user U and researcher R loses the first service point, for example, at the following timings. That is, the user U loses the first service point at the timing of withdrawing from the service and the timing of presenting a problem (the timing of creating a problem solving program). Furthermore, although not illustrated, it loses the first service point at the timing of providing the first service point to the researcher R. The researcher R loses the first service point at the timing of withdrawing from the service.

In addition, as illustrated in FIG. 2A, the researcher R gains the second service point at the following timings. That is, the researcher R gains the second service point at the timing of posting (releasing) a research result and the timing of ranking highly in the first service point gain ranking (e.g., the “Ranking of researcher points” described above).

In addition, as illustrated in FIG. 2A, the researcher R loses the second service point at the following timings. That is, the researcher R loses the second service point at the timing of deleting a research result, the timing of purchasing laboratory equipment or the like at a partnership shopping site, and the timing of withdrawing from the service.

On the research result distribution platform P, research results posted by researchers R are stored in a database. Therefore, in the research posting service, a search system that allows a desired research result to be easily extracted can be provided to users U.

In addition, on the research result distribution platform P, research results posted by researchers R are managed in a proprietary format and therefore, in the research posting service, it is possible to easily perform translation to a predetermined language such as English. This also makes it possible to hold the World biggest conference all of which can be completed on the research result distribution platform P. As a result, a circle of knowledge by researchers R around the world can be formed. In addition, although will be described later, the proprietary format can include moving image data.

Among the specific services that utilize the research result distribution platform P, the “problem solving support service” is a service provided for the purpose of performing matching between “pieces of knowledge” exchanged between a company having a problem and a researcher R. In the problem solving support service, presentation of a problem by a company as a user U and presentation of a solution by a researcher R are performed on the research result distribution platform. In addition, a company that has presented a problem also can designate a desired researcher R from among a plurality of researchers R who use the research result distribution platform; and can ask them to offer a solution to the problem. A researcher R presenting a solution can present a solution only by inputting a specific content of the solution in a predetermined input format prepared in a predetermined page of the research result distribution platform, in a similar manner to posting of a research result described above. The contents that are input to the input format by the researcher R are automatically coded into an HTML format.

A specific process for using the problem solving support service is as follows. That is, a company as a user U inputs its own problem into a predetermined input format prepared in a predetermined page of the research result distribution platform. In response to this, the content of the problem that is presented by the company is placed on the research result distribution platform. Then, a researcher R who is interested in the problem placed on the research result distribution platform posts a solution to the problem by using an input method described above. The company that has presented the problem carefully selects and adopts an outstanding solution from among posted solutions.

As described above, a researcher R can get the service point at the timing of posting a solution and at the timing when the posted solution is adopted. In addition, when a solution is adopted by the company that has presented the problem, a researcher R who has posted the solution can gain an incentive for adoption of the solution together with or separately from the service point. More specifically, a researcher R whose solution has been adopted can gain, as “research fund”, cash as an incentive. Note that the incentive may be paid from the company that has adopted the solution directly to the researcher R or may be paid via a service provider G. The service provider G can set the billing of usage fee and the content of a charge to be paid in the case where a posted solution is adopted, for a user U (company) that uses the problem solving support service.

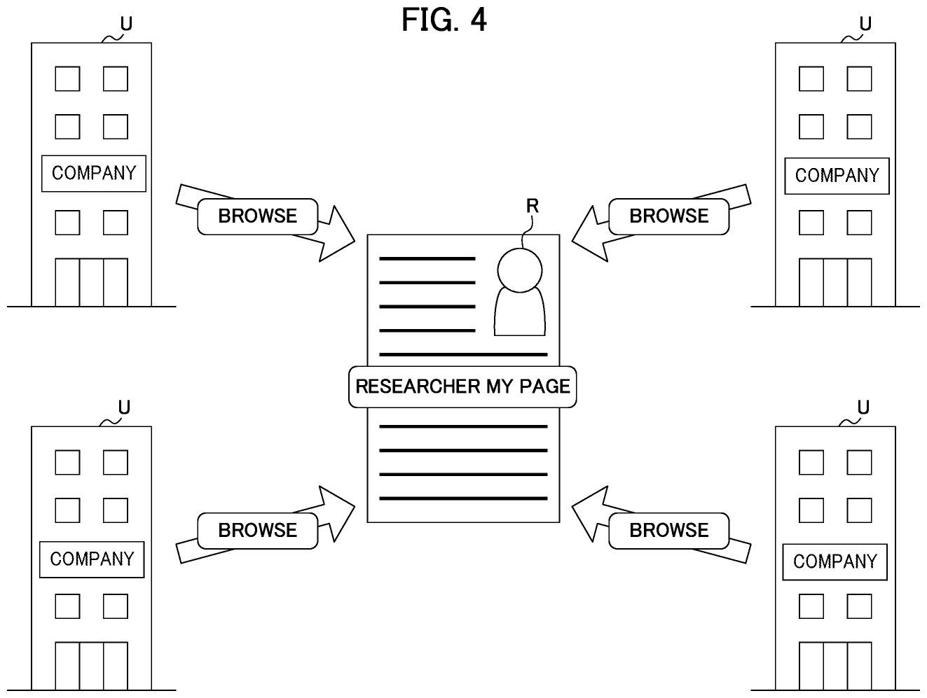

Among the specific services that utilize the research result distribution platform P, the “recruit automatic scouting service” is a service that allows various appeals that can be made by a researcher R to companies to be automatically made. The recruit automatic scouting service will be described later with reference to FIG. 4.

Among the specific services that utilize the research result distribution platform P, the “record creation service” is a service of outputting registered researcher information in a predetermined format (hereinafter, referred to as “record format”). A researcher R inputs information on a predetermined web page where they can freely edit own researcher information (hereinafter, referred to as “researcher my page”), where they input information such as a face photo, division, and department name and in addition, personal information such as hobbies, self-introduction, skills, projects involved in the past, and a goal desired to be achieved in the future. More specifically, in inputting information on the researcher my page, the researcher R can perform inputting, setting, or the like of: a profile, career, awards, major achievements (theses, books, postings, invited talks, patents, etc.), research results in the past, main research themes, research-related keywords, confirmation of research POST posting status, joint research requests, thesis data, history of browsing favorite company information, history of being scouted by companies, evaluations from users U (e.g., the number of times of pressing the “LIKE IT” button), wanting or not wanting to be scouted, changing of login password, editing of my page contents, setting of search categories (types of business), access history, and editing of research POST (uploading/editing/deleting).

Entry forms (formats) for at least several tens of entry items in a document that is to be created for application for various grants are not unified and each entry has to be performed each time, which is a cumbersome work for applicants (researchers R). In the service, an applicant (researcher R) performs a predetermined operation (e.g., operation of dragging a text file as it is) and thereby, information on, for example, the following items can be automatically assigned for each item. That is, it is possible to automatically assign information on each of the items: name, affiliated institution name, location, laboratory, position, telephone number, e-mail address, educational background, referee, achievements, author's name, scientific journal name (volume (issue), pages, year), appealing points, subsidized project name, project plan, purpose of subsidized project, project performance so far, a goal and procedure of a project of this year, subsidized project plan, subsidized project period, implementation system, place of implementation (main place), person in charge, person in charge of project, person in charge of accounting, and the like. Note that, after assignment of the items is automatically performed, the applicant (researcher R) can also edit, while modifying, item positions manually (e.g., operation of dragging or the like) by themselves. After editing, the researcher R presses a predetermined button (e.g., an OK button). With this, the researcher R can perform download with automatic conversion into a file of an original input format having been performed.

In the record creation service, characters that are input in a predetermined format can be automatically converted into characters and the like in a desired format. For example, through an automatic ruby generation function of the record creation service, when joyo kanji (regular-use Chinese characters) that early elementary school students have not learned yet is input, ruby (furigana, a Japanese reading aid) is automatically placed above the kanji. In addition, for example, through an automatic conversion and translation to plain language function of the record creation service, difficult sentences ranging over the whole text are automatically translated by technology such as artificial intelligence (AI) or the like, so as to provide their meanings in plain Japanese at a level of being understandable even for elementary school students. In addition, idioms that are classified into a difficult level are translated into plain language.

Among the specific services that utilize the research result distribution platform P, the “lab sharing service” is a service of loaning an idle asset (e.g., laboratory equipment) that a researcher R, or a company, a general individual, and the like as users U own, to a researcher R who is requiring it. This allows a currently unused asset to be used by a researcher R who requires it, thereby creating new value and leading to profits. In the case of loaning an asset by general lease or rental, a loaner side is limited to a fixed range, for example, companies in its industry (rental/lease industry). However, in the lab sharing service, a researcher R, or a company, a general individual, and the like as users U can also be a loaner side, which leads to the gaining of those who use the service. In the lab sharing service, a process from negotiation to settlement of rental fee/lease fee can be performed on the research result distribution platform P. A service provider G may also collect, in providing a lab sharing service to a researcher R or user U, the commission thereof of “the number of service use days x a predetermined proportion of a lease fee”.

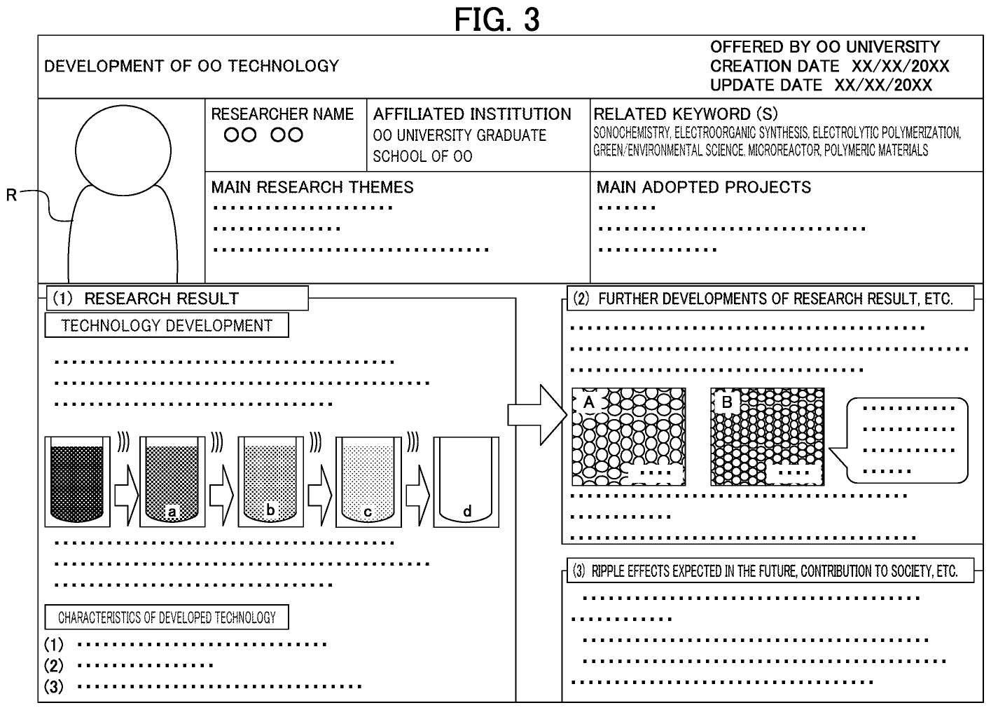

FIG. 3 is a diagram illustrating a specific example of the proprietary format provided by the research posting service included in the service.

As described above, in the research posting service, a research result posted by a researcher R can be presented in and outside the country in the proprietary format. As illustrated in FIG. 3, the proprietary format consists of an upper section and a lower section; on the upper section, bibliographic items are mainly arranged and on the lower section, items of the specific content of a research result are arranged. More specifically, on the upper section of the proprietary format, such items are arranged as: the theme of a research result (in an example of FIG. 3, “Development of OO technology”), a source of the research result (in the example of FIG. 3, “Offered by OO university), creation date and update date (in the example of FIG. 3, “Creation date: XX/XX/20XX”, “Update date: XX/XX/20XX”), the photographed image of a researcher R, the name of the researcher R (in the example of FIG. 3, “OO OO”), the name of an institution with which the researcher R is affiliated (in the example of FIG. 3, “OO university graduate school of OO”), keywords related to the research result (in the example of FIG. 3, “sonochemistry, electroorganic synthesis, electrolytic polymerization, green/environmental science, microreactor, polymeric materials”), main research themes, and main adopted projects. In addition, on the lower section of the proprietary format, such items are arranged as: “(1) Research result”, “(2) Further developments of the research result, etc.”, “(3) Ripple effects expected in the future, contribution to the society, etc.”.

Furthermore, although not illustrated, the proprietary format can include moving image data that can be easily edited by the researcher R. Therefore, data of one- or two-minute moving image in which a researcher R explains a summary for each individual research result, for example, can be included. More specifically, for example, the researcher R can easily create data of a moving image beginning with the phrase of “In sum, this research . . . ” and ending with the phrase of “therefore, is research that can be expected to contribute to the OO field.” and can have it included.

FIG. 4 is a diagram illustrating an overview of the recruit automatic scouting service included in the service.

As described above, the recruit automatic scouting service is a service that allows various appeals that can be made by a researcher R to companies to be automatically made. In the recruit automatic scouting service, the researcher R can get such an appeal automatically made to companies that are users U, as being willing to change jobs or having a desire for joint research with a company, for example.

A company as a user U who seeks human resources and promotes research can find at a glance the existence of researchers R who are making a self-recommendation. This allows the company to easily perform information collection such as searching for human resources and searching for joint research. In addition, the company can also approach to a desired researcher R actively. In this case, the company performs a predetermined operation on a predetermined web page (hereinafter, referred to as “company my page”) where information on themselves (hereinafter, referred to as “company information”) can be edited. This allows the company to indicate, to a desired researcher R, an intention to do joint research with them or an intention to recruit them as a staff member. It should be noted that a specific method for a company to indicate, to a desired researcher R, an intention to do joint research with them or an intention to recruit them as a staff member is not particularly limited. A company can indicate, to a desired researcher R, an intention to do joint research with them or an intention to recruit them as a staff member by pressing a button (not illustrated) saying “Exchange business cards”, which is provided on a company my page, for example.

A researcher R performs a predetermined operation on a researcher my page. This allows the researcher R to indicate, to companies, whether they want to do joint research or not and whether they want to change jobs or not. It should be noted that a specific method for the researcher R to indicate, to companies, whether they want to do joint research or not and whether they want to change jobs or not is not particularly limited. The researcher R can indicate, to companies, whether they want to do joint research or not and whether they want to change jobs or not by pressing a button (not illustrated) saying “Exchange business cards”, which is provided on a researcher my page, for example. This allows negotiations for employment or the like between a company and the researcher R to be started.

In addition, a researcher R who desires that the above appeal be automatically performed performs an operation of checking a predetermined check box (hereinafter, referred to as “scout request box”) which is provided on a researcher my page. When the operation of checking the scout request box is performed, a predetermined symbol sign indicating as such is displayed as a “want-to-be scouted message” on the web page in a manner that only companies can browse it. Thus, companies can browse information on the researcher R who wants to change jobs or to do joint research; and therefore, the researcher R is only required to wait to be scouted by companies.

It should be noted that the range of researcher information of researchers R that can be browsed by companies is not particularly limited. For example, in using the service, paying member companies may be allowed to browse a wider range of researcher information (e.g., all information on the profiles of researchers R) than companies as those who do not pay (so-called free members). In addition, in the recruit automatic scouting service, profile data that can be created on a researcher my page is used as a profile of a researcher R. Therefore, the researcher R can be saved from having to redundantly input information including similar contents.

Next, the configuration of an information processing system that achieves provision of the service described above, that is, the information processing system including a server 1 according to one embodiment of the information processing device of the present invention will be described with reference to FIG. 5. FIG. 5 is a diagram illustrating a configuration of the information processing system including the server according to one embodiment of the information processing device of the present invention.

The information processing system illustrated in FIG. 5 is configured to include the server 1, researcher terminals 2-1 to 2-n (n is an integer value equal to or greater than 1), and user terminals 3-1 to 3-m (m is an integer value equal to or greater than 1). The server 1, the researcher terminals 2-1 to 2-n, and the user terminals 3-1 to 3-m are connected with each other via a predetermined network N such as the Internet.

The server 1 is managed by a service provider G; and executes various kinds of processing for implementing the service while appropriately communicating with the researcher terminals 2-1 to 2-n and the user terminals 3-1 to 3-m.

The researcher terminals 2-1 to 2-n are information processing devices that are operated by researchers R1 to Rn, respectively; each of which is configured with, for example, a personal computer, a smartphone, a tablet, or the like. Note that when it is not necessary to discriminate between the individual researchers R1 to Rn, they are collectively called “researcher R”. In addition, when it is not necessary to discriminate between the individual researcher terminals 2-1 to 2-n, they are collectively called “researcher terminal 2”.

The user terminals 3-1 to 3-m are information processing devices that are operated by users U1 to Um, respectively; each of which is configured with, for example, a personal computer, a smartphone, a tablet, or the like. Note that when it is not necessary to discriminate between the individual users U1 to Um, they are collectively called “user U”. In addition, when it is not necessary to discriminate between the individual user terminals 3-1 to 3-m, they are collectively called “user terminal 3”.

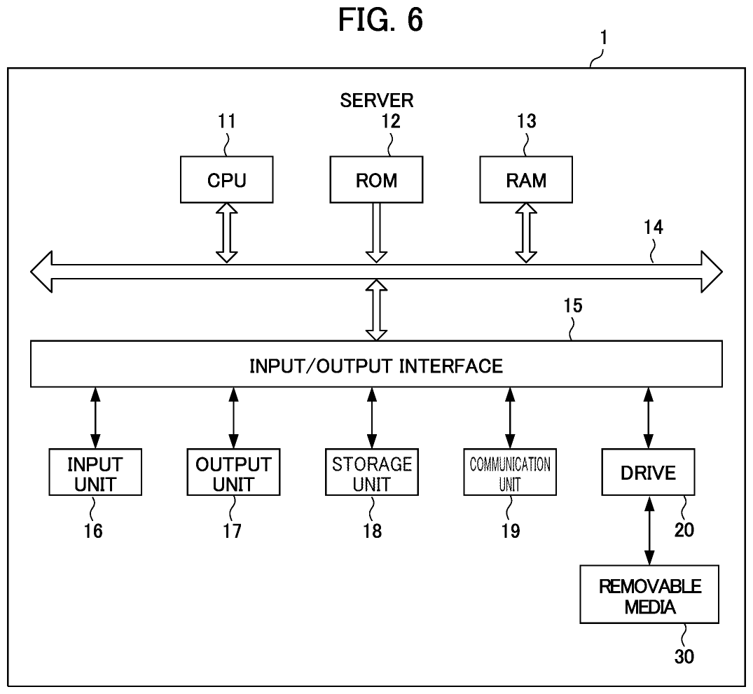

FIG. 6 is a block diagram illustrating one example of a hardware configuration of the server in the information processing system illustrated in FIG. 5.

The server 1 includes: a central processing unit (CPU) 11, a read only memory (ROM) 12, a random access memory (RAM) 13, a bus 14, an input/output interface 15, an input unit 16, an output unit 17, a storage unit 18, a communication unit 19, and a drive 20.

The CPU 11 executes various kinds of processing according to programs stored in the ROM 12 or programs loaded from the storage unit 18 to the RAM 13. In the RAM 13, data that is necessary for the CPU 11 to execute various kinds of processing, and the like are also appropriately stored.

The CPU 11, the ROM 12, and the RAM 13 are mutually connected via the bus 14. To this bus 14, the input/output interface 15 is also connected. To the input/output interface 15, the input unit 16, the output unit 17, the storage unit 18, the communication unit 19, and the drive 20 are connected.

The input unit 16 is configured with, for example, a keyboard and the like, and outputs various kinds of information. The output unit 17 is configured with a display of liquid crystal or the like, a speaker, and the like and outputs various kinds of information as images or sounds. The storage unit 18 is configured with dynamic random access memory (DRAM) and the like, and stores various kinds of data. The communication unit 19 communicates with other devices (e.g., the researcher terminal 2, the user terminal 3, and the like in FIG. 5) via the network N including the Internet.

In the drive 20, a magnetic disk, an optical disk, a magneto-optical disk, or a removable media 30 including a semiconductor memory and the like is mounted as appropriate. A program that is read out from the removable media 30 by the drive 20 is installed in the storage unit 18 as required. In addition, the removable media 30 can also store various kinds of data that is stored in the storage unit 18, as with the storage unit 18.

Although not illustrated, the researcher terminal 2 and user terminal 3 in FIG. 5 also can have basically the same configuration as that of the hardware configuration illustrated in FIG. 6. Therefore, the description of the hardware configurations of the researcher terminal 2 and the user terminal 3 is omitted.

Cooperation between various kinds of hardware in the server 1 in FIG. 6 which are described above and various kinds of software allows execution of various kinds of processing including the research result utilization support processing in the server 1. As a result, the service provider G can provide the service described above to the researchers R and the users U. The “research result utilization support processing” refers to processing that is executed to provide the service described above. Hereinafter, functional components for executing the research result utilization support processing, which are executed in the server 1, will be described.

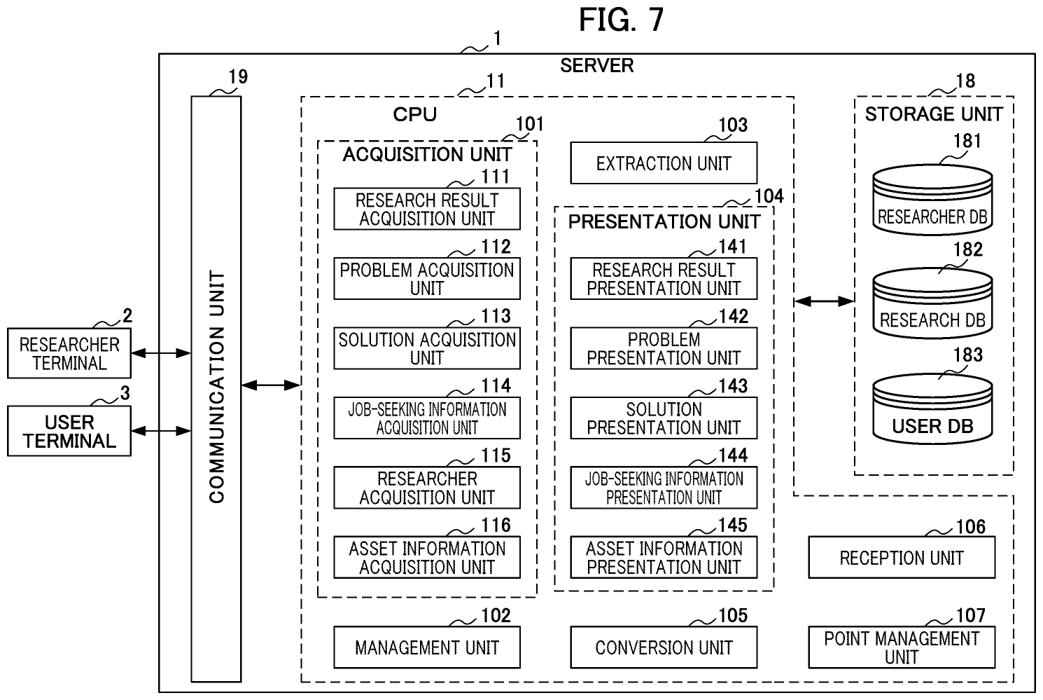

FIG. 7 is a functional block diagram illustrating functional components for executing the research result utilization support processing, out of the functional components of the server in FIG. 6.

As illustrated in FIG. 7, in a CPU 11 of the server 1, when execution of the research result utilization support processing is controlled, an acquisition unit 101, a management unit 102, an extraction unit 103, a presentation unit 104, a conversion unit 105, a reception unit 106, and a point management unit 107 function.

The acquisition unit 101 acquires various kinds of information. In the acquisition unit 101, a research result acquisition unit 111, a problem acquisition unit 112, a solution acquisition unit 113, a job-seeking information acquisition unit 114, a researcher acquisition unit 115, and an asset information acquisition unit 116 function.

The research result acquisition unit 111 acquires research result information as first information indicating a result of research of a researcher R. The research result information acquired by the research result acquisition unit 111 is stored and managed in a research DB 182. The problem acquisition unit 112 acquires problem information as second information on a predetermined problem that is presented by a company as a user U. The problem information acquired by the problem acquisition unit 112 is stored and managed in the research DB 182. The solution acquisition unit 113 acquires, when a solution to a problem is presented from a researcher R, solution information as third information indicating the solution. The solution information acquired by the solution acquisition unit 113 is stored and managed in the research DB 182. The job-seeking information acquisition unit 114 acquires fourth information on whether a researcher R is seeking a job or not, as job-seeking information. The job-seeking information acquired by the job-seeking information acquisition unit 114 is stored and managed in a researcher RB 181. The researcher acquisition unit 115 acquires fifth information on a researcher R, as researcher information. The researcher information acquired by the researcher information acquisition unit 115 is stored and managed in the researcher RB 181. The asset information acquisition unit 116 acquires sixth information on assets related to research, which are owned by each of at least one researcher R and at least one user U, as owned asset information. The owned asset information acquired by the asset information acquisition unit 116 is stored and managed in either the researcher RB 181 or a user DB 183 in which information on users U is stored.

The management unit 102 manages at least one piece of the first information acquired by the research result acquisition unit 111, as at least one piece of the research result information, for each researcher R. More specifically, the management unit 102 manages each of at least one piece of research result information stored in the research DB 182, for each of at least one researchers R stored in the researcher RB 181.

The extraction unit 103 extracts research result information desired by a user U from among the at least one piece of research result information managed by the management unit 102. More specifically, the extraction unit 103 extracts research result information that comes up by a search operation of a user U from among the at least one piece of research result information that is stored and managed in the research DB 182.

The presentation unit 104 presents various kinds of information. In the presentation unit 104, a research result presentation unit 141, a problem presentation unit 142, a solution presentation unit 143, a job-seeking information presentation unit 144, and an asset information presentation unit 145 function.

The research result presentation unit 141 presents the research result information as the first information that is extracted by the extraction unit 103, to a user U. More specifically, the research result presentation unit 141 causes the research result information that is extracted by the extraction unit 103 to be displayed on the user terminal 3, thereby presenting it to the user U.

The problem presentation unit 142 presents the problem information as the second information that is acquired by the problem acquisition unit 112, to at least one researcher R. More specifically, the problem presentation unit 142 causes the problem information acquired by the problem acquisition unit 112 to be displayed on each of the researcher terminals 2-1 to 2-n, thereby presenting it to each of the researchers R1 to Rn.

The solution presentation unit 143 presents the solution information as the third information that is acquired by the solution acquisition unit 113, to a user. More specifically, the solution presentation unit 143 causes the solution information acquired by the solution acquisition unit 113 to be displayed on the user terminal 3, thereby presenting it to the user U.

The job-seeking information presentation unit 144 presents the job-seeking information as the fourth information that is acquired by the job-seeking information acquisition unit 114, to at least one user U. More specifically, the job-seeking information presentation unit 144 causes the job-seeking information acquired by the job-seeking information acquisition unit 114 to be displayed on each of the user terminals 3-1 to 3-m, thereby presenting it to each of the users U1 to Um.

The asset information presentation unit 145 generates loan asset information as the seventh information on assets loanable to any of at least one researcher R, based on the owned asset information as the sixth information that is acquired by the asset information acquisition unit 116. Then, the asset information presentation unit 145 presents the generated loan asset information to at least one researcher R. More specifically, the asset information presentation unit 145 generates the loan asset information and causes it to be displayed on each of the researcher terminals 2-1 to 2-n, thereby presenting it to each of the researchers R1 to Rn.

The conversion unit 105 converts the research result information acquired by the research result acquisition unit 111, into a predetermined common format. More specifically, the conversion unit 105 converts the research result information acquired by the research result acquisition unit 111, into a proprietary format that is provided by the research posting service described above.

The reception unit 106 receives an evaluation by at least one user U regarding the research result information that is presented by the research result presentation unit 141. More specifically, the reception unit 106 receives, as the evaluation by users U regarding research result information that is presented by the research result presentation unit 141, information indicating the number of times of pressing the “LIKE IT” button and information on feedback from the user U, for example.

The point management unit 107 gives a predetermined incentive to a researcher R, based on the content of the evaluation by the user U which is received by the reception unit 106. More specifically, for example, the point management unit 107 gives the service point as an incentive to a researcher R, based on the content of an evaluation by a user U. In addition, the point management unit 107 manages the number of the service points that are gained by a researcher R and the number of the service points that are used.

Although the above has described one embodiment of the present invention, the present invention is not limited to the embodiment described above, but modifications or improvements are also included in the scope of the present invention as long as the object of the present invention can be achieved.

For example, a specific method for the researcher R and the user U to use the service is not particularly limited. For example, the service may be used by using application software (hereinafter, referred to as an “app”) dedicated to the service (hereinafter, referred to as a “dedicated app”) which is downloaded from a web site providing the app and is installed in each of the researcher terminal 2 and user terminal 3. This allows the researcher R and the user U to use at least part of the service even in an offline environment. Further, a method using the dedicated app is not limited thereto and alternatively, for example, the service may be used by using each browser function of the researcher terminal 2 or the user terminal 3.

In addition, for example, although in the problem solving support service described above, a problem is presented by a company as a user U, this is merely an exemplification. The user U who presents a problem may be, for example, a country, the Corporation, any organization, a general individual, or a researcher R as a user U.

Furthermore, for example, a relationship between the service point and actions illustrated in FIG. 2A and FIG. 2B is merely an exemplification. The user U and the researcher R may gain or lose the service point at timings other than those of the actions illustrated in FIG. 2A and FIG. 2B. Further, although the service point illustrated in FIG. 2A and FIG. 2B includes two kinds thereof (the first service point and the second service point), this is also merely an exemplification. The service point may include one kind thereof, or may include three or more kinds of service points that have different use values.

Furthermore, for example, in the embodiment described above, the service point is given to the researcher R and the user U; however, this is merely an exemplification. An incentive to the researcher R and user U may be, for example, cash, any product (e.g., laboratory equipment), or the like.

Still furthermore, for example, a series of processes described above may be executed by hardware or may be executed by software. Moreover, one functional block may be configured by a single unit of hardware, may be configured by a single unit of software, or may be configured in a combination thereof.

When the series of processes is executed by software, a program constituting the software is installed from a network or recording medium to a computer or the like. The computer may be a computer incorporated in dedicated hardware. Alternatively, the computer may be a computer capable of executing various functions by having various programs installed therein, for example, a server or a general-purpose smartphone or personal computer.

The recording medium including such programs is configured not only by an unillustrated removable media, which is distributed separately from the device itself to supply the programs to users, but also by a recording medium or the like which is supplied to the users in a state of being incorporated in the device main body in advance.

It should be noted that in the present description, steps describing a program recorded in a recording medium include not only processing performed in time sequence in accordance with the described sequence but also processing not necessarily performed in time sequence but performed in parallel or individually. In addition, the term of “system” in the present description means the overall apparatus including a plurality of devices and a plurality of means.

In summary, an information processing device to which the present invention is applied (e.g., the server 1 in FIG. 7) only needs to have the following configuration and can implement various embodiments. That is, the information processing device to which the present invention is applied includes: a first acquisition unit (e.g., the research result acquisition unit 111 in FIG. 7) that acquires first information (e.g., research result information) indicating a result of research by a researcher; a management unit (e.g., the management unit 102 in FIG. 7) that manages, for each researcher, at least one piece of the first information acquired by the first acquisition unit; an extraction unit (e.g., the extraction unit 103 in FIG. 7) that extracts the first information desired by a user, from among the at least one piece of the first information managed by the management unit; and a first presentation unit (e.g., the research result presentation unit 141 in FIG. 7) that presents the first information extracted by the extraction unit, to the user.

Thus, at least one piece of the research result information posted by a researcher is properly managed for each researcher. In addition, from among them, a research result desired by a user is extracted and presented to the user. As a result, the research result distribution platform that is highly convenient for researchers and users can be provided.

In addition, it may further include a conversion unit (conversion unit 105) that converts the first information acquired by the first acquisition unit, into a predetermined common format (e.g., a proprietary format).

This makes it possible to easily convert a research result into a proprietary format. As a result, for example, the research posting service among the specific services that utilize the research result distribution platform P described above can also be provided.

In addition, it may further include: a reception unit (reception unit 106) that receives an evaluation (e.g., “LIKE IT”) by at least one of the users regarding the first information presented by the first presentation unit; and a giving unit (point management unit 107) that gives a predetermined incentive (e.g., the service point) to the researcher, based on the content of the evaluation (e.g., the number of “LIKE ITs”) received by the reception unit.

This makes it possible to give the service point as an incentive to a researcher, based on the content of an evaluation by a user regarding a research result.

Furthermore, it may also include: a second acquisition unit (e.g., the problem acquisition unit 112 in FIG. 7) that acquires second information (e.g., problem information) on a predetermined problem that is presented by the user; a second presentation unit (e.g., the problem presentation unit 142 in FIG. 7) that presents the second information acquired by the second acquisition unit, to the at least one researcher; a third acquisition unit (e.g., the solution acquisition unit 113 in FIG. 7) that when a solution to the problem is presented by the researcher, acquires the solution as the third information (e.g., solution information); and a third presentation unit (e.g., the solution presentation unit 143 in FIG. 7) that presents the third information acquired by the third acquisition unit, to the user.

This makes it possible to easily perform the sharing of a problem presented by a user and the presentation of a solution to the problem by a researcher. As a result, for example, it also makes it possible to provide the problem solving support service among the specific services that utilize the research result distribution platform P described above.

Furthermore, it may also include: a fourth acquisition unit (job-seeking information acquisition unit 114) that acquires information (e.g., job-seeking information) on whether the researcher is seeking a job or not, as fourth information; and a fourth presentation unit (job-seeking information presentation unit 144) that presents the fourth information acquired by the fourth acquisition unit, to the at least one user.

This makes it possible to perform matching between an intention to seek a job on a researcher side and an intention to employ on a user (e.g., company) side. As a result, for example, it also makes it possible to provide the recruit automatic scouting service among the specific services that utilize the research result distribution platform P described above.

Still furthermore, it may also include a fifth acquisition unit (researcher acquisition unit 115) that acquires information on the researcher as the fifth information (e.g., researcher information); wherein the management unit further can perform: management of the fifth information acquired by the fifth acquisition unit, for each of the at least one researcher.

This makes it possible to properly manage detailed information on researchers. As a result, for example, it also makes it possible to provide the record creation service among the specific services that utilize the research result distribution platform P described above.

Yet furthermore, it may also include: a sixth acquisition unit (asset information acquisition unit 116) that acquires information on an asset related to the research (e.g., owned asset information), which is owned by each of the at least one researcher and the at least one user, as the sixth information; and a fifth presentation unit (asset information presentation unit 145) that generates seventh information (e.g., loan asset information) on the asset loanable to any of the at least one researcher based on the sixth information acquired by the sixth acquisition unit, and presents it to the at least one researcher.

This makes it possible to easily perform matching between a researcher or user who owns an idle asset and a researcher who needs it. As a result, for example, it also makes it possible to provide the lab sharing service among the specific services that utilize the research result distribution platform P described above.

EXPLANATION OF REFERENCE NUMERALS

1: Server, 2, 2-1 to 2-n: Researcher terminal 3, 3-1 to 3-m: User terminal, 11: CPU, 12: ROM, 13: RAM, 14: Bus, 15: Input/output interface, 16: Input unit, 17: Output unit, 18: Storage unit, 19: Communication unit, 20: Drive, 30: Removable media, 101: Acquisition unit, 102: Management unit, 103: Extraction unit, 104: Presentation unit, 105: Conversion unit, 106: Reception unit, 107: Point management unit, 111: Research result acquisition unit, 112: Problem acquisition unit, 113: Solution acquisition unit, 114: Job-seeking information acquisition unit, 115: Researcher acquisition unit, 116: Asset information acquisition unit, 141: Research result presentation unit, 142: Problem presentation unit, 143: Solution presentation unit, 144: Job-seeking information presentation unit, 145: Asset information presentation unit, 181: Researcher DB, 182: Research DB, 183: User DB, G: Service provider, R, R1 to Rn: Researcher, U, U1 to Um: User, N: Network

1. An information processing device comprising:
a first acquisition unit that acquires first information indicating a result of research by a researcher;
a management unit that manages, for each researcher, at least one piece of the first information acquired by the first acquisition unit;
an extraction unit that extracts first information desired by a user, the first information being among the at least one piece of the first information managed by the management unit;
a first presentation unit that presents the first information extracted by the extraction unit, to the user,
a reception unit that receives an evaluation by at least one of the users regarding the first information presented by the first presentation unit; and
a giving unit that gives a predetermined incentive to the researcher, based on a content of the evaluation received by the reception unit.

2. The information processing device according to claim 1, further comprising:
a conversion unit that converts the first information acquired by the first acquisition unit, into a predetermined common format.

3. (canceled)

4. The information processing device according to claim 1, further comprising:
a second acquisition unit that acquires second information on a predetermined problem presented by the user;
a second presentation unit that presents the second information acquired by the second acquisition unit, to the at least one researcher;
a third acquisition unit that when a solution to the problem is presented by the researcher, acquires the solution as third information; and
a third presentation unit that presents the third information acquired by the third acquisition unit, to the user.

5. The information processing device according to claim 1, further comprising:
a fourth acquisition unit that acquires information on whether the researcher is seeking a job or not, as fourth information; and
a fourth presentation unit that presents the fourth information acquired by the fourth acquisition unit, to the at least one user.

6. The information processing device according to claim 1, further comprising:
a fifth acquisition unit that acquires information on the researcher as fifth information;
wherein
the management unit further performs:
management of the fifth information acquired by the fifth acquisition unit, for each of the at least one researcher.

7. The information processing device according to claim 1, further comprising:
a sixth acquisition unit that acquires information on an asset related to the research as sixth information, the asset being owned by each of the at least one researcher and the at least one user; and
a fifth presentation unit that generates seventh information on the asset loanable to any of the at least one researcher based on the sixth information acquired by the sixth acquisition unit, and presents it to the at least one researcher.
